(19) United States
(12) Patent Application Publication
(10) Pub. No.: US 2008/0178069 A1
(43) Pub. Date: Jul. 24, 2008

(54) Content Authoring System and Method

(76) Inventor: Richard W. Stallings, Plymouth, MI (US)

Correspondence Address: HOLLAND & KNIGHT LLP, 10 ST. JAMES AVENUE, 11th Floor, BOSTON, MA, 02116-3889, US

(21) Appl. No.: 11/736,316

(22) Filed: Apr. 17, 2007

Related U.S. Application Data
(63) Continuation-in-part of application No. 11/625,534, filed on Jan. 22, 2007.
(60) Provisional application No. 60/891,600, filed on Feb. 26, 2007.

(51) Int. Cl. G06F 17/00; G06F 17/30; G06F 3/00; G06F 3/048

(52) U.S. Cl. 715/202; 707/1; 715/731; 715/764

(57) ABSTRACT

A method and computer program product for defining a selected non-sequential content template. The selected non-sequential content template defines a plurality of data objects and includes at least one non-sequential navigation object that allows for non-sequential navigation between at least a portion of the plurality of data objects defined within the selected non-sequential content template.

### RELATED APPLICATIONS

This application claims priority to the following: U.S. patent application Ser. No. 11/625,534,^{✓} filed 22 Jan. 2007,^{✓} entitled “Data Presentation System and Method” (H&K Docket No.: 111228.00009) and U.S. Patent Application Ser. No. 60/891,600, filed 26 Feb. 2007,^{✓} entitled “System and Method for Preparing a Video Presentation” (H&K Docket No.: 111228.00010), which are herein incorporated by reference.

### TECHNICAL FIELD

This disclosure relates to content templates and, more particularly, to content templates that allow for non-sequential navigation of content.

### BACKGROUND

When generating and viewing content, the creator of such content may be constrained by the manner in which the user may navigate through the various pages of the content. For example, word processor documents may require that the user scroll through the pages in a linear fashion. For example, if the user is reviewing page one of a document and wishes to review page five of the document, the user may be required to scroll through page two, page three, and page four in order to get to page five. Additionally, when viewing a presentation (i.e., a slide show) in presentation mode, the user may be required to sequentially skip through various intermediary slides in order to get to the slide that the user wishes to review.

### SUMMARY OF DISCLOSURE

In a first implementation, a content authoring method includes defining a selected non-sequential content template. The selected non-sequential content template defines a plurality of data objects and includes at least one non-sequential navigation object that allows for non-sequential navigation between at least a portion of the plurality of data objects defined within the selected non-sequential content template.

One or more of the following features may be included. A plurality of non-sequential content templates may be stored in a data repository. The selected non-sequential content template may be chosen from the plurality of non-sequential content templates. The data repository may be chosen from the group consisting of: a database and a directory structure.

The selected non-sequential content template may include: two or more discrete animation sequences for applying to at least a portion of the plurality of data objects. The plurality of data objects may include: a first data object, and a second data object. The two or more discrete animation sequences may include: a first animation sequence for applying to the first data object, and a second animation sequence for applying to the second data object.

The selected non-sequential content template may be modified. Modifying the selected non-sequential content template may include at least one of: adding one or more additional data objects to the selected non-sequential content template; adding one or more discrete animation sequences to the selected non-sequential content template; deleting one or more of the plurality of data objects from the selected non-sequential content template; deleting one or more discrete animation sequences from the selected non-sequential content template; and modifying one or more of the plurality of data objects defined within the selected non-sequential content template to include customer content.

The customer content may be chosen from the group consisting of: customer text; customer images; customer animations; customer video tracks; and customer audio tracks. The selected non-sequential content template may be configured to assist a user in creating content, such as e.g., a slideshow presentation file and/or a word processor file.

In another implementation, a computer program product resides on a computer readable medium and has a plurality of instructions stored on it. When executed by a processor, the instructions cause the processor to perform operations including defining a selected non-sequential content template. The selected non-sequential content template defines a plurality of data objects and includes at least one non-sequential navigation object that allows for non-sequential navigation between at least a portion of the plurality of data objects defined within the selected non-sequential content template.

One or more of the following features may be included. A plurality of non-sequential content templates may be stored in a data repository. The selected non-sequential content template may be chosen from the plurality of non-sequential content templates. The data repository may be chosen from the group consisting of: a database and a directory structure.

The selected non-sequential content template may include: two or more discrete animation sequences for applying to at least a portion of the plurality of data objects. The plurality of data objects may include: a first data object, and a second data object. The two or more discrete animation sequences may include: a first animation sequence for applying to the first data object, and a second animation sequence for applying to the second data object.

The selected non-sequential content template may be modified. Modifying the selected non-sequential content template may include at least one of: adding one or more additional data objects to the selected non-sequential content template; adding one or more discrete animation sequences to the selected non-sequential content template; deleting one or more of the plurality of data objects from the selected non-sequential content template; deleting one or more discrete animation sequences from the selected non-sequential content template; and modifying one or more of the plurality of data objects defined within the selected non-sequential content template to include customer content.

The customer content may be chosen from the group consisting of: customer text; customer images; customer animations; customer video tracks; and customer audio tracks. The selected non-sequential content template may be configured to assist a user in creating content, such as e.g., a slideshow presentation file and/or a word processor file.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a content authoring process coupled to a distributed computing network;

FIG. 2 is a flowchart of the content authoring process of FIG. 1;

FIG. 3 is a diagrammatic view of a user interface screen rendered by the content authoring process of FIG. 1;

FIG. 4 is a diagrammatic view of a screen rendered by the content authoring process of FIG. 1;

FIG. 5 is a diagrammatic view of a screen rendered by the content authoring process of FIG. 1;

FIG. 6 is a diagrammatic view of a screen rendered by the content authoring process of FIG. 1;

FIG. 7 is a diagrammatic view of a screen rendered by the content authoring process of FIG. 1;

FIG. 8 is a diagrammatic view of a screen rendered by the content authoring process of FIG. 1;

FIG. 9 is a diagrammatic view of a screen rendered by the content authoring process of FIG. 1;

FIG. 10 is a diagrammatic view of a screen rendered by the content authoring process of FIG. 1;

FIG. 11 is a diagrammatic view of a screen rendered by the content authoring process of FIG. 1;

FIG. 12 is a diagrammatic view of a screen rendered by the content authoring process of FIG. 1;

FIG. 13 is a diagrammatic view of a screen rendered by the content authoring process of FIG. 1; and

FIG. 14 is a diagrammatic view of a screen rendered by the content authoring process of FIG. 1.

### DETAILED DESCRIPTION OF THE PREFERRED EMBODIMENTS

### System Overview:

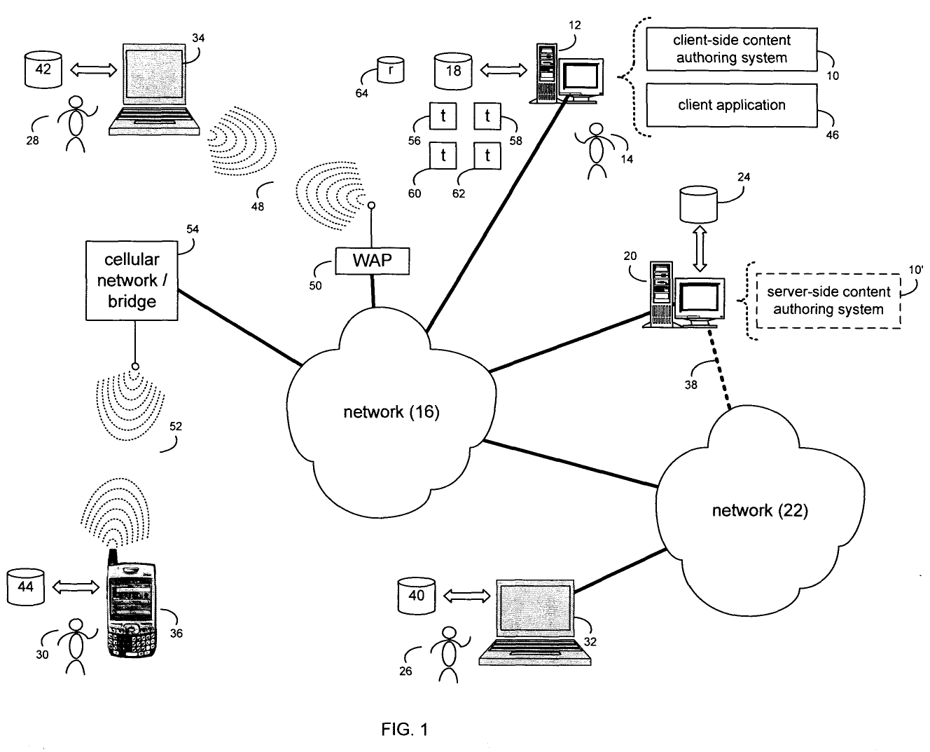

Referring to FIG. 1, there is shown a content authoring process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, content authoring process 10 may allow a user 14 to author a presentation that includes a plurality of data objects (e.g., data pages and data screens) and at least one non-sequential navigation object that allows for non-sequential navigation between at least a portion of the plurality of data objects defined within the selected non-sequential content template.

Content authoring process 10 may be a client-side application that resides on and is executed by e.g., client computer 12, which may be connected to network 16 (e.g., the Internet). The instruction sets and subroutines of content authoring process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, the above-described content authoring process may be a server-based application, as represented in FIG. 1 by server-side content authoring process 10′ (shown in phantom). Server-side content authoring process 10′ may reside on and may be executed by data server 20, which may be coupled to network 16. Examples of data server 20 may include, but are not limited to: a personal computer, a server computer, a series of server computers, a mini computer, and a mainframe computer, for example. Data server 20 may execute a network operating system, examples of which may include but are not limited to: Microsoft Windows XP Server ™; Novell Netware ™; or Redhat Linux ™, for example.

Data server 20 may execute a web server application, examples of which may include but are not limited to: Microsoft IIS ™, Novell Webserver ™, or Apache Webserver ™, that allows for HTTP (i.e., HyperText Transfer Protocol) access to data server 20 via network 16. Network 16 may be coupled to one or more secondary networks (e.g., network 22), examples of which may include but are not limited to: a local area network; a wide area network; or an intranet, for example.

The instruction sets and subroutines of server-side content authoring process 10′, which may be stored on a storage device 24 coupled to data server 20, may be executed by one or more processors (not shown) and one or more memory architectures (not shown) incorporated into data server 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the content authoring process may be a client-side application (e.g., client-side content authoring process 10), a server-side application (e.g., server-side content authoring process 10′), or a hybrid client-side/server-side application (e.g., using portions of both client-side content authoring process 10 and server-side content authoring process 10′). Accordingly, the manner in which the content authoring process is accessed may vary depending on whether the content authoring process is a client-side application, a server-side application, or a hybrid client-side/server-side application.

If a client-side application, users 14, 26, 28, 30 may access the client-side content authoring process (e.g., client-side content authoring process 10) directly through the device on which the client-side content authoring process is executed, namely client computer 12, notebook computer 32, laptop computer 34 and personal digital assistant 36, for example. The instruction sets and subroutines of client-side content authoring process 10, which may be stored on a storage device (e.g., storage device 18, 40, 42, 44) coupled to the computing device (e.g., client computer 12, notebook computer 32, laptop computer 34 and personal digital assistant 36, respectively) executing client-side content authoring process 10, may be executed by one or more processors (not shown) and one or more memory architectures (not shown) incorporated into the computing device executing client-side content authoring process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, if a server-side application, users 14, 26, 28, 30 may access the server-side content authoring process (e.g., server-side content authoring process 10′) through network 16 or through secondary network 22. Data server 20 (i.e., the computer that executes server-side content authoring process 10′) may be coupled to network 16 through secondary network 22, as illustrated with phantom link line 38.

If accessing server-side content authoring process 10′, client computer 12, notebook computer 32, laptop computer 34 and personal digital assistant 36 may each execute a client application (e.g., client application 46) that may interface with server-side content authoring process 10′ and facilitate the bidirectional transfer of data between e.g., client computer 12 and data server 20.

The client application (e.g., client application 46) may be a web browser (e.g., Microsoft Internet Explorer ™ and Netscape Navigator ™, for example), a stand alone application, or an applet running within another program (e.g., Microsoft Internet Explorer ™ and Netscape Navigator ™, for example).

Client computer 12, notebook computer 32, laptop computer 34 and personal digital assistant 36 may each execute an operating system, examples of which may include but are not limited to Microsoft Windows ™, Microsoft Windows Mobile ™, Redhat Linux ™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Content Authoring Process:

As discussed above, the content authoring process may be a client-side application, a server-side application, or a hybrid client-side/server-side application. Accordingly, the following disclosure is applicable to all variants of the content authoring process.

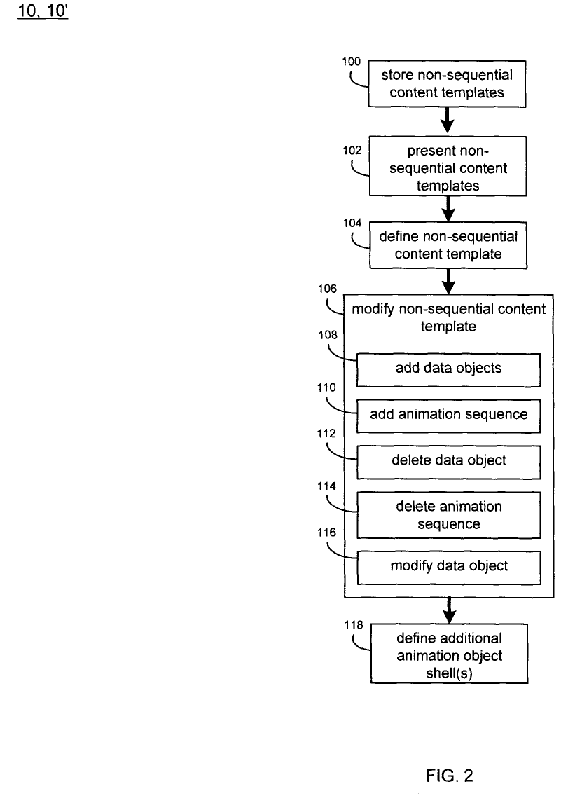

Referring also to FIG. 2, content authoring process 10, 10′ may store 100 a plurality of non-sequential content templates (e.g., templates 56, 58, 60, 62) in a data repository 64. Examples of data repository 64 may include, but are not limited to, a database (e.g., an Oracle ™ database, an IBM DB2 ™ database, a Sybase ™ database, a Computer Associates ™ database or a Microsoft Access ™ database) or a traditional directory/subdirectory data structure. Data repository 62 may be included within storage device 18.

Each of the plurality of non-sequential content templates (e.g., templates 56, 58, 60, 62) may define the general “look and feel” of the content (e.g., a word processor file and/or a slideshow presentation file) being generated. Each of the non-sequential content templates 56, 58, 60, 62 may define a plurality of data objects and may define at least one non-sequential navigation object that allows for non-sequential navigation between at least a portion of the plurality of data objects defined within the non-sequential content template. For example, a first non-sequential content template (e.g., template 56) may be a tabbed slideshow template that includes five tabs (positioned along the top of the template), each of which is linked to a unique data object (e.g., a page/slide) and allows for non-sequential navigation between the data objects. A second non-sequential content template (e.g., template 58) may be a tabbed slideshow template that includes four tabs (positioned along the side of the template), each of which is linked to a unique data object (e.g., a page/slide) and allows for non-sequential navigation between the data objects.

Each of the plurality of non-sequential content templates (e.g., templates 56, 58, 60, 62) may include two or more discrete animation sequences for applying to at least a portion of the data objects defined within the content template. The non-sequential content templates (e.g., templates 56, 58, 60, 62) may allow the user (e.g., user 14) to control the manner in which data objects (e.g., pages/slides) included within the content (e.g., a word processor file and/or a slideshow presentation file) being generated by the user are manipulated. For example, through the use of a non-sequential content template (e.g., templates 56, 58, 60, 62), the user (e.g., user 14) may control the manner in which one or more data objects included within the content being generated are introduced. For example, if a slide within a slideshow presentation is to include photographs of the four founders of a company, the non-sequential content template (e.g., template 62, 64) may control the manner and sequence in which the individual photographs appear within the particular slide. For example, a non-sequential content template (e.g., template 60) may have each of the four photographs sequentially fade in. Alternatively, another non-sequential content template (e.g., template 62) may have each of the four photographs slide into view from off screen.

Content authoring process 10, 10′ may be a stand-alone application or may be a process incorporated into (i.e., executed within) another application, examples of which may include but are not limited to Microsoft Word ™ and Microsoft PowerPoint ™. Accordingly, when initiating content authoring process 10, 10′, user 14 may launch content authoring process 10, 10′ (if a stand-alone process) or may launch the application (Microsoft Word ™ and Microsoft PowerPoint ™) into which content authoring process 10 is incorporated.

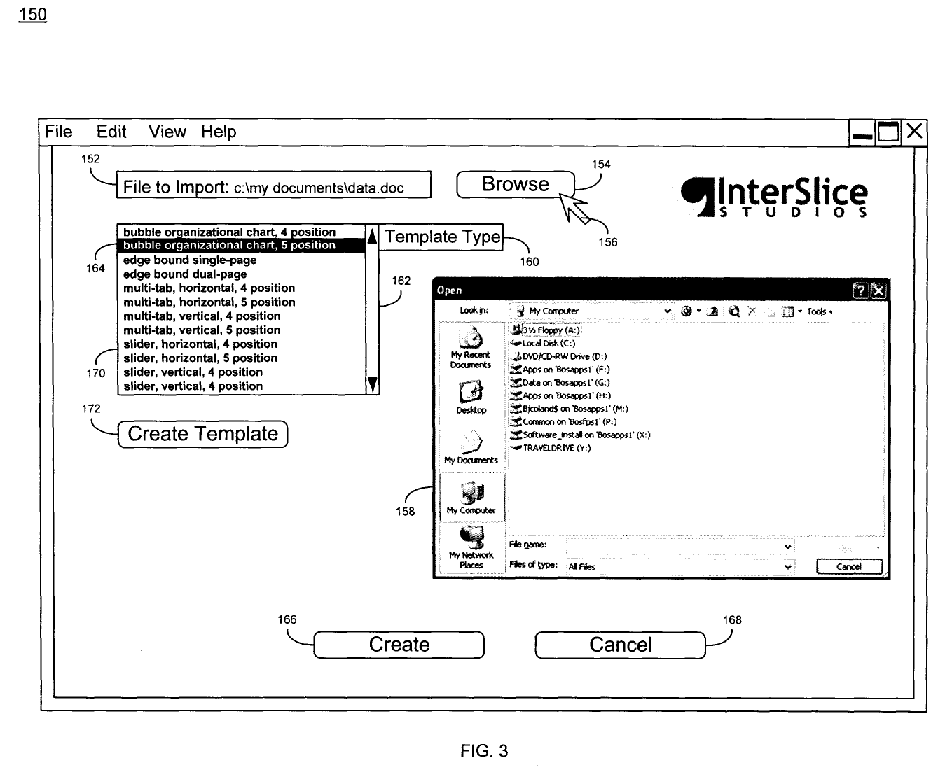

Referring also to FIG. 3, content authoring process 10, 10′ may render user interface screen 150, which allows a user (e.g., user 14) to perform various tasks associated with generating content using a non-sequential content template (e.g., templates 56, 58, 60, 62). As discussed above, examples of the type of content that may be generated may include, but are not limited to, a slideshow presentation file and/or a word processor file.

The manner in which user interface screen 150 is presented to the user may vary depending on whether the content authoring process is a client-side application, a server-side application, or a hybrid client-side/server-side application. For example, if a client-side application, user interface 150 may be locally-rendered and presented to the user via e.g., locally-executed, client-side content authoring process 10. Alternatively, if the content authoring process is a server-side application, user interface 150 may be remotely-rendered and presented to the user via e.g., remotely-executed, server-side content authoring process 10′. Further, if a hybrid client-side/server-side content authoring process, user interface 150 may be locally-rendered and presented to the user via e.g., locally-executed, client-side content authoring process 10. However, various non-sequential content templates may be provided to client-side content authoring process 10 by server-side content authoring process 10′ via network 16 (or network 22).

When generating content using content authoring process 10, 10′, user interface screen 150 may allow the user (e.g., user 14) to import all or a portion of the data (e.g., text and/or images) to be included within the content. Accordingly, user interface screen 150 may include a “File to Import” field 152 that allows the user to define the location of a data file to be imported. The user may manually define the location of the data file by e.g., typing a path and file name (e.g., c:\my documents\data.doc) directly into field 152. Additionally/alternatively, user interface 150 may include a “Browse” button 154, which may be selectable via an onscreen pointer 156 that may be controllable by a pointing device such as a mouse (not shown). Once “Browse” button 154 is selected, a “browsing window” 158 may be rendered by content authoring process 10, 10′. Browsing window 158 may allow the user to “browse” the directory structure of e.g., client computer 12 and define the data file for import. An example of a data file type that may be imported may include, but is not limited to, a word processing data file, such as those generated using Microsoft Word ™ and/or a Joint Photographic Experts Group (i.e., JPEG) file.

Additionally/alternatively, content authoring process 10, 10′ may allow the user to author the data to be included within the content. Therefore, if the user wishes to author (i.e., and not import) the data, the user may e.g., leave field 152 blank and, therefore, no data file will be imported.

Content authoring process 10, 10′ may present 102 all or a portion of the available non-sequential content templates (e.g., templates 56, 58, 60, 62) included within data repository 64 to the user (e.g., user 14) for review and selection. User interface 150 may include e.g., a “Template Type” field 160 that allows the user to define 104 a non-sequential content template for use in creating the content. When selecting “Template Type” field 160 (using onscreen pointer 156), dropdown menu 162 may be rendered by content authoring process 10, 10′ that defines a plurality of available non-sequential content templates. For example and in this embodiment, dropdown menu 162 is shown to include twelve available non-sequential content templates, namely: bubble organizational chart, 4 position; bubble organizational chart, 5 position; edge bound single-page; edge bound dual-page; multi-tab, horizontal, 4 position; multi-tab, horizontal, 5 position; multi-tab, vertical, 4 position; multi-tab, vertical, 5 position; slider, horizontal, 4 position; slider, horizontal, 5 position; slider, vertical, 4 position; and slider, vertical, 4 position. While this list is intended to be illustrative, it is not intended to be exhaustive. Accordingly, other non-sequential content templates are considered to be within the scope of this disclosure.

Assume that, after reviewing dropdown menu 162, user 14 would like the content that they are creating (using content authoring process 10, 10′) to include a five position bubble organizational chart. Accordingly, user 14 may select (using onscreen pointer 156) the “bubble organizational chart, 5 position” non-sequential content template line item 164 from the plurality of available non-sequential content templates defined within dropdown menu 162.

Once the non-sequential content template line item 164 is selected and (if desired) the data to be imported is defined, the user may select (using onscreen pointer 156) “Create” button 166. Alternatively, user 14 may select “Cancel” button 168, which may e.g., terminate content authoring process 10, 10′ or clear fields 152, 160.

If “Create” button 166 is selected, content authoring process 10, 10′ may generate content in accordance with the non-sequential content template selected. As discussed above, in the event that no data file is selected for import, the content being generated may be “empty” of data (e.g., contain only blank fields). Accordingly and in this scenario, user 14 may be presented with an “empty” non-sequential content template (i.e., a non-sequential content template that contains no data but is formatted in accordance with the selected non-sequential content template). Assuming that user 14 selected a data file for import (e.g., c:\my documents\data.doc), upon selecting “Create” button 166, content authoring process 10, 10′ may generate a non-sequential content template that is wholly or partially filled with data.

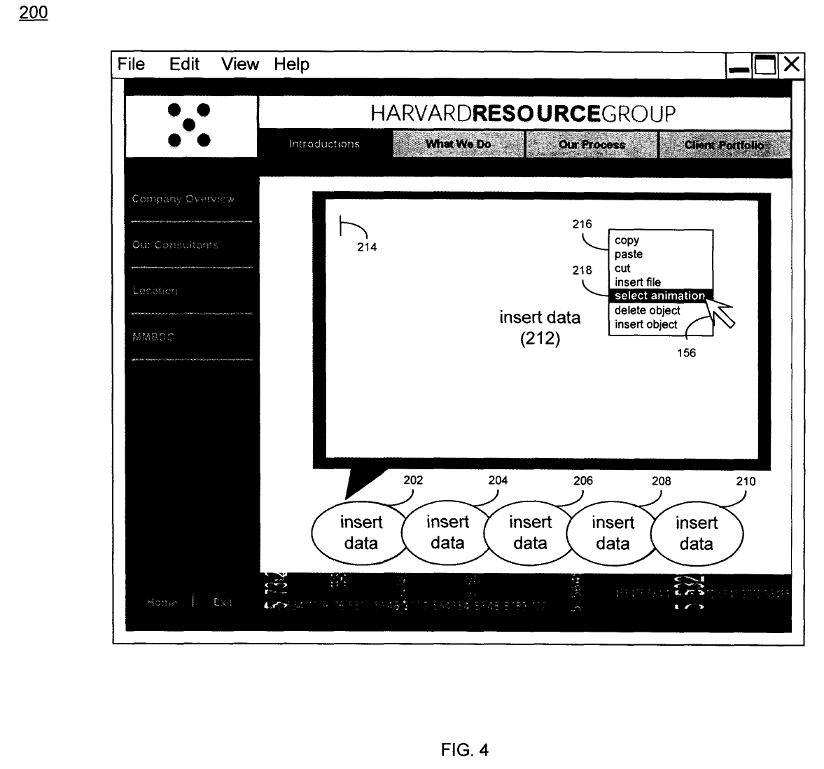

Continuing with the above-stated example and referring also to FIG. 4, “bubble organizational chart, 5 position” non-sequential content template 200 may be rendered by content authoring process 10, 10′. Non-sequential content template 200 may include a plurality of data objects, and various animation sequences that may be applied to the data objects included within the template. Additionally, non-sequential content template may define a non-sequential navigation object that allows for non-sequential navigation between at least a portion of the data objects defined within non-sequential content template 200. Examples of data objects may include, but are not limited to, content pages, data “bubbles” and data boxes, for example.

In this particular example, non-sequential content template 200 is shown to include five data “bubbles” 202, 204, 206, 208, 210, each of which may be associated with one or more content pages. For example, data “bubble” 202 may be associated with content page 212, and each of data “bubbles” 204, 206, 208, 210 may be associated with other unique content pages (not shown). Accordingly, by selecting data “bubble” 202, content page 212 may be rendered by content authoring process 10, 10′; and by selecting data “bubble” 204, a different content page (not shown) may be rendered by content authoring process 10, 10′, for example. Therefore, the combination of data “bubbles” 202, 204, 206, 208, 210, in this particular example, forms a non-sequential navigation object that allows for non-sequential navigation between the various content pages associated with the various data “bubbles”.

When selecting data “bubble” 202, an animation sequence may be initiated that results in the rendering of content page 212. This animation sequence (when initiated) may result in e.g., content page 212 fading into view, sliding into view from the left, or sliding into view from the right.

Content authoring process 10, 10′ may allow e.g., user 14 to modify 106 non-sequential content template 200, which may include: e.g., adding 108 data objects (e.g., content pages, data “bubbles” and data boxes) to template 200; adding 110 animation sequences to template 200; deleting 112 data objects (e.g., content pages, data “bubbles” and data boxes) from template 200; deleting 114 animation sequences from template 200; and/or modifying 116 the various data objects (e.g., content pages, data “bubbles” and data boxes) included within template 200.

When modifying 116 a data object (e.g., populating a data object with data and/or editing the data included within a data object), the data may include, but is not limited to, text-based data, image-based data, video-based data, and/or audio-based data. Often this data may be custom tailored content for a particular customer, examples of which may include but are not limited to, customer text; customer images; customer animations; customer video tracks; and customer audio tracks.

As discussed above, this data may be imported in file format or manually entered. To modify 116 a data object (e.g., content pages, data “bubbles” and data boxes), user 14 may select the data object using onscreen pointer 156. Once selected, cursor 214 may appear within e.g., content page 212 that allows user 14 to enter text. Additionally/alternatively, user 14 may enter non-text data by e.g., “right clicking” the pointing device (not shown) while onscreen pointer 156 is above the data object into which the data is to be placed. “Right clicking” may result in the generation of popup menu 216. Popup menu 216, which may be rendered by content authoring process 10, 10, may include a plurality of options, such as: “copy”, “paste”, “cut”, and “insert file”. By selecting e.g., “insert file”, a file selection window (not shown), that may be similar to “browsing window” 158 (FIG. 3) may be rendered by content authoring process 10, 10′, which may allow user 14 to select the file to be inserted. As discussed above, the file to be inserted may be a text-based file (e.g., a Microsoft Word ™ file), an image-based file (e.g., a JPEG file), a video-based file (e.g., a AVI file), and/or an audio-based file (e.g., an MP3 file), for example.

Popup window 216 may additionally include a “select animation” option 218 that may allow user 14 to select the type of animation to be associated with the data object being modified 106. For example, by selecting “select animation” from popup window 216, user 14 may be presented with an animation selection window (not shown) that may allow user 14 to select an animation sequence for the object in question. For example, user 14 may be allowed to select between various animation sequences, examples of which may include but are not limited to: fade in, fade out, slide in left, slide in right, slide in top, slide in bottom, slide out left, slide out right, slide out top, and slide out bottom, for example.

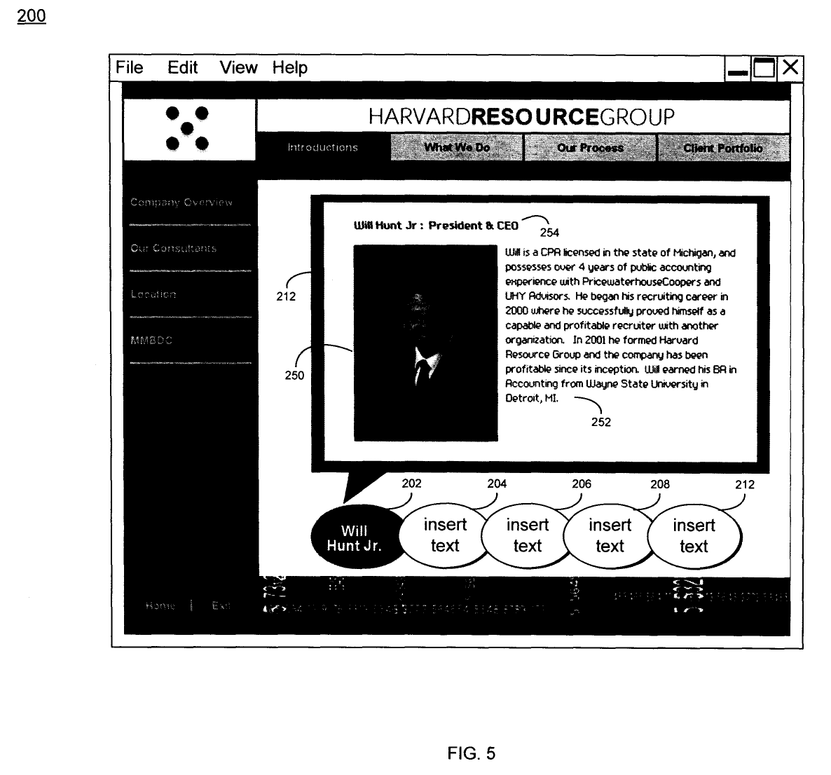

Referring also to FIG. 5, a first completed data object (i.e., content page 212) and a second completed data object (i.e., data “bubble” 202) are shown. In this particular example, data “bubble” 202 was modified 116 to include name information (e.g., “Will Hunt Jr.”) and content page 212 was modified 116 to include photograph 250, biographical information 252, and title information 254.

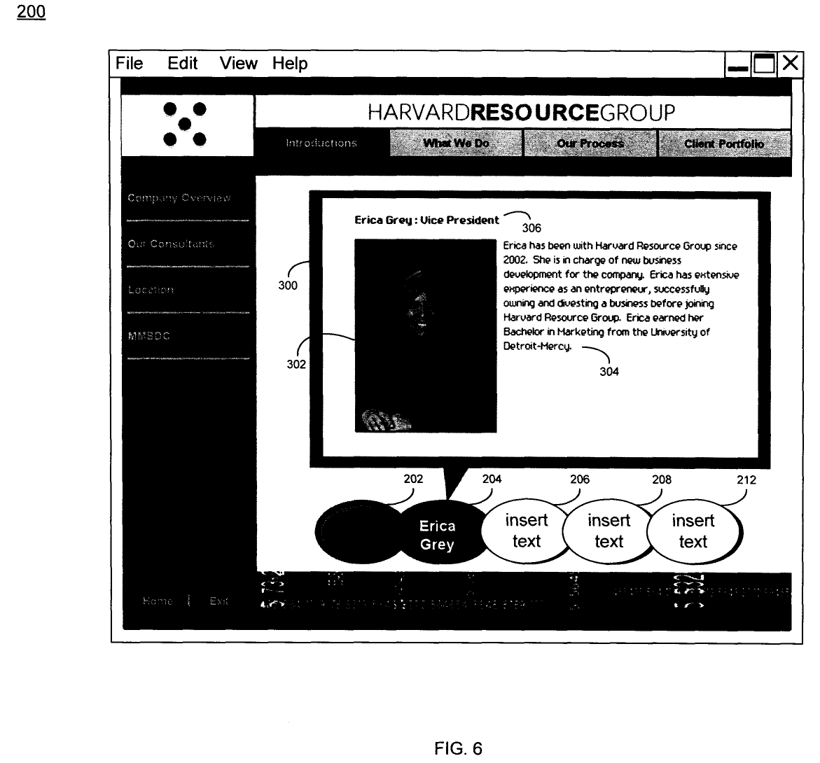

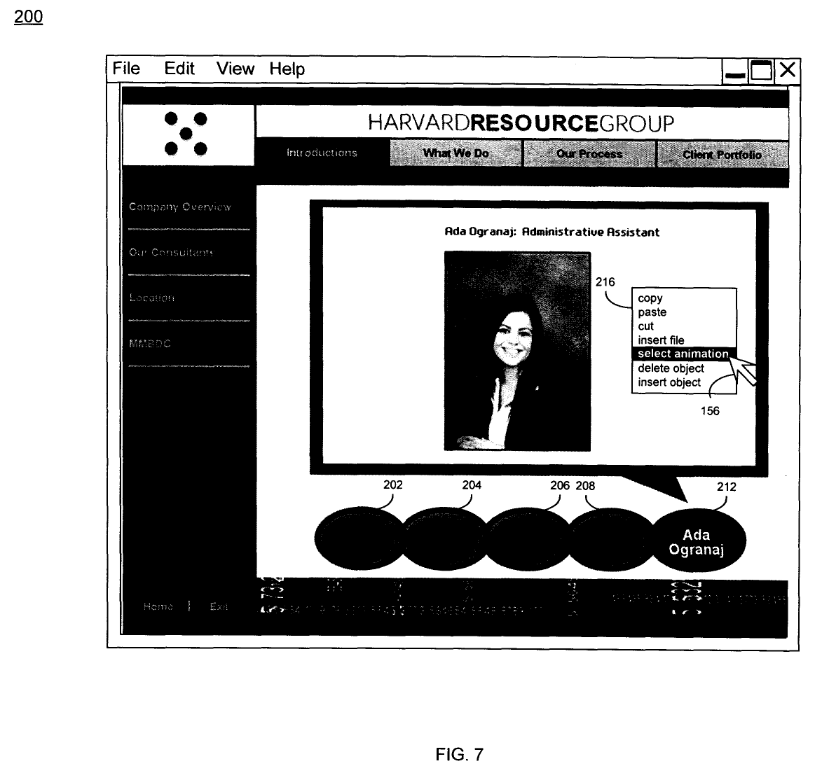

Referring also to FIG. 6, once e.g., data “bubble” 202 and content page 212 are populated with data, user 14 may select e.g., data “bubble” 204. Once selected, content authoring process 10, 10′ may render content page 300 (i.e., the content page associated with data “bubble” 204). As discussed above, user 14 may modify 116 data “bubble” 204 to include name information (e.g., “Erica Grey”) and content page 212 may be modified 116 to include photograph 302, biographical information 304, and title information 306. As discussed above, user 14 may select the animation sequence to be associated with e.g., content page 300. Referring also to FIG. 7, this process may be continued until each data “bubble” and each content page (associated with each data bubble) is populated (i.e., modified 116 to include e.g., name information and bibliographic information).

As discussed above, content authoring process 10, 10′ may allow e.g., user 14 to edit 106 non-sequential content template 200, which may include: e.g., adding 108 data objects (e.g., content pages, data “bubbles” and data boxes) to template 200; adding 110 animation sequences to template 200; deleting 112 data objects (e.g., content pages, data “bubbles” and data boxes) from template 200; deleting 114 animation sequences from template 200; and/or modifying 116 the various data objects (e.g., content pages, data “bubbles” and data boxes) included within template 200. Accordingly, in the event that a content page, data “bubble” and data box needs to be added 108 or removed 112, user 14 may “right click” the pointing device (not shown) and content authoring process 10, 10′ may render popup menu 216. User 14 may then select (using onscreen pointer 156) either “delete object” (e.g., to delete the data object positioned beneath onscreen point 156) or “insert object” (e.g., to insert a data object, such as a content page, data “bubble” and data box). As discussed above, being a data object may have an animation sequence associated with it, when adding 108 a new data object, content authoring process 10, 10′ may allow user 14 to add 110 a new animation sequence for association with the newly-added data object.

As discussed above and as illustrated in FIG. 3, content authoring process 10, 10′ may allow user 14 to select from a plurality of non-sequential content template, examples of which include but are not limited to: bubble organizational chart, 4 position; bubble organizational chart, 5 position; edge bound single-page; edge bound dual-page; multi-tab, horizontal, 4 position; multi-tab, horizontal, 5 position; multi-tab, vertical, 4 position; multi-tab, vertical, 5 position; slider, horizontal, 4 position; slider, horizontal, 5 position; slider, vertical, 4 position; and slider, vertical, 4 position. While this list is intended to be illustrative, it is not intended to be exhaustive. Accordingly, other non-sequential content templates are considered to be within the scope of this disclosure.

Accordingly, assuming that user 14 completes the previously-selected “bubble organization chart, five position”, user 14 may select an additional non-sequential content template. For example, assume that user 14 selects the “slider, horizontal, 4 position” line item 170 (FIG. 3).

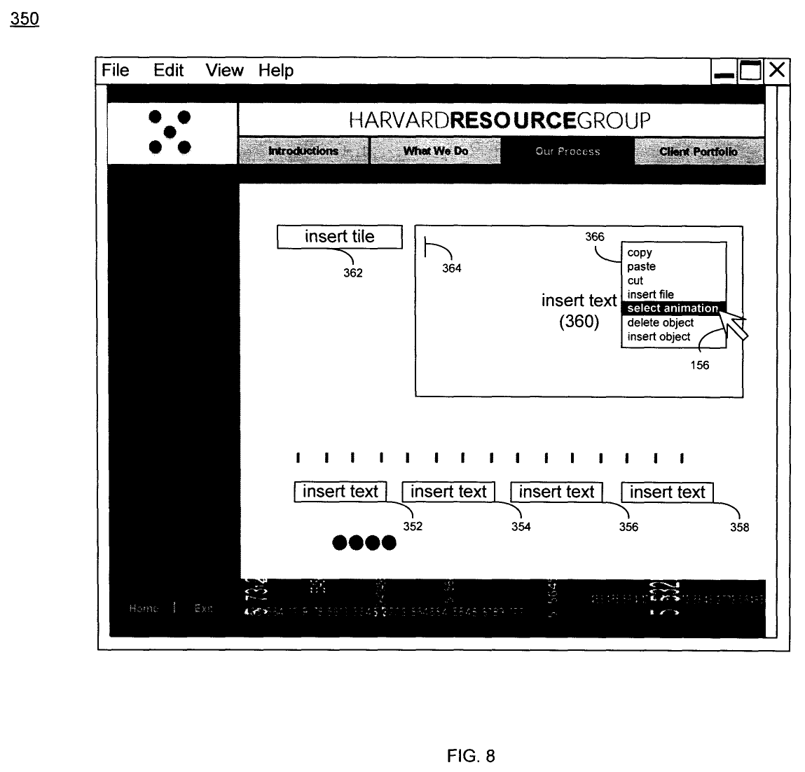

Continuing with the above-stated example and referring also to FIG. 8, “slider, horizontal, 4 position” non-sequential content template 350 may be rendered by content authoring process 10, 10′. Non-sequential content template 350 may include a plurality of data objects, a non-sequential navigation object for navigating between the various data objects, and various animation sequences that may be applied the data object(s).

In this particular example, non-sequential content template 350 is shown to include four slider data objects 352, 354, 356, 358, each of which may be associated with one or more content pages. For example, slider data object 352 is associated with content pages 360, 362 and each of slider data objects 354, 356, 358 may be associated with other unique content pages (not shown). Accordingly, the combination of slider data objects 352, 354, 2356, 358 may form a non-sequential navigation object that allows for non-sequential navigation between the various unique content pages defined within template 350. Therefore, by selecting: slider data object 352, content pages 360, 362 may be rendered by content authoring process 10, 10′; and by selecting slider data object 354, a different content page (not shown) may be rendered by content authoring process 10, 10′, for example. Accordingly, when selecting slider data object 352, an animation sequence may be initiated that may result in the rendering of content pages 360, 362. This animation sequence (when initiated) may result in e.g., content pages 360, 362 fading into view, sliding into view from the left, or sliding into view from the right, for example.

Content authoring process 10, 10′ may allow e.g., user 14 to edit 106 non-sequential content template 350, which may include e.g., adding 108 data objects (e.g., slider data objects, content pages, data “bubbles” and data boxes) to template 350; adding 110 animation sequences to template 350; deleting 112 data objects (e.g., slider data objects, content pages, data “bubbles” and data boxes) from template 350; deleting 114 animation sequences from template 350; and/or modifying 116 the various data objects (e.g., slider data objects, content pages, data “bubbles” and data boxes) included within template 350.

As discussed above, user 14 may select a data object using onscreen pointer 156. Once selected, cursor 364 may appear within e.g., content page 360 that allows user 14 to enter text. Additionally/alternatively, user 14 may enter non-text data by e.g., “right clicking” the pointing device (not shown) while onscreen pointer 156 is above the data object into which the data is to be placed. “Right clicking” may result in the generation of popup menu 366. Popup menu 366 may include a plurality of options, such as: “copy”, “paste”, “cut”, and “insert file”. By selecting e.g., “insert file”, a file selection window (not shown), that may be similar to “browsing window” 158 (FIG. 3) may be rendered by content authoring process 10, 10′, which may allow user 14 to select the file to be inserted.

As discussed above, popup window 366 may additionally include a “select animation” option that may allow user 14 to select the animation associated with the data object being edited.

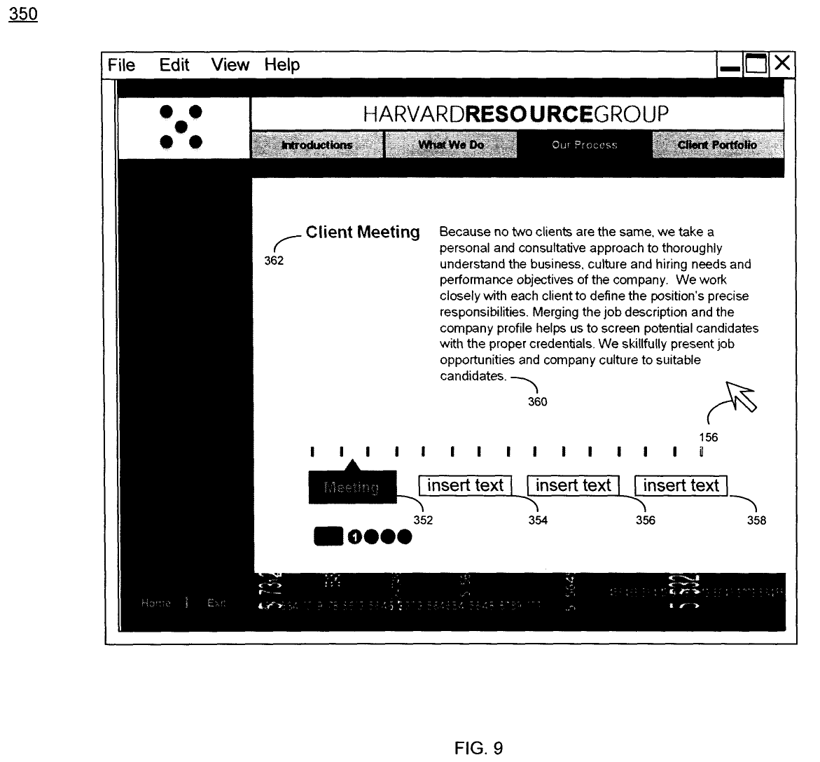

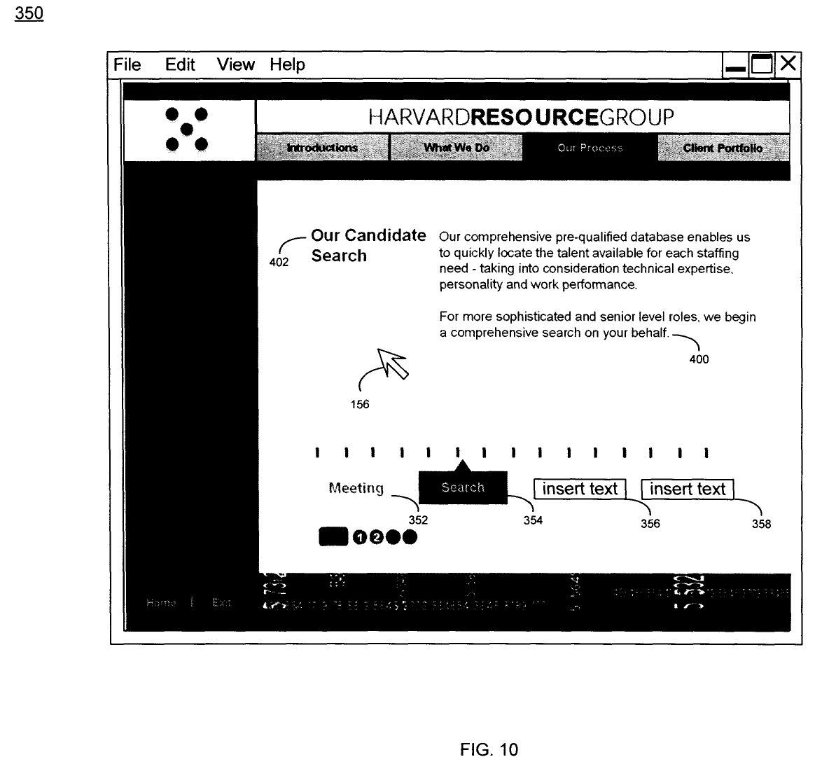

Referring also to FIGS. 9-10, there is shown template 350 at various stages of completion. For example, FIG. 9 illustrates template 350 after slider data object 352 and content pages 360, 362 have been populated with (in this example) text. Further, FIG. 10 illustrates template 350 after slider data object 354 and content pages 400, 402 (i.e., the content pages associated with slider data object 354) have been populated with (in this example) text.

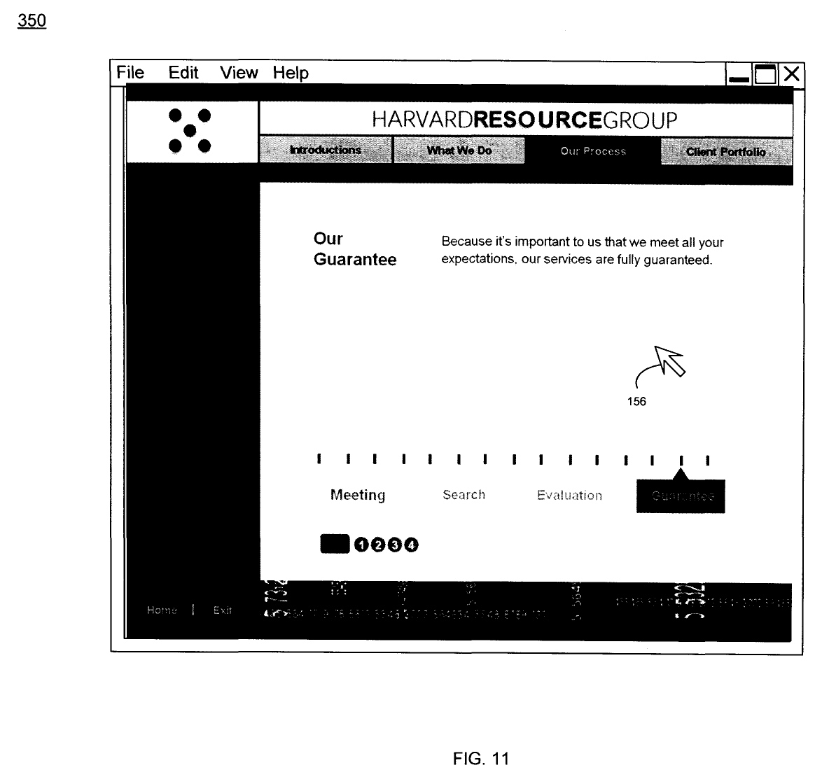

Referring also to FIG. 11, this process may be continued until each slider data object and each content page (associated with each slider data object) is populated.

Referring again to FIG. 3, while content authoring process 10, 10′ provides a plurality of animation object templates (illustrated within dropdown menu 162), content authoring process 10, 10′ may allow user 14 to define 116 custom templates. For example, user 14 may select “Create Template” button 172 using onscreen pointer 156. Once selected, an non-sequential content template authoring screen (not shown) may be rendered by content authoring process 10, 10′ that allows e.g., user 14 to define 118 (FIG. 2) additional animation object templates for inclusion within the plurality of animation object templates defined within dropdown menu 162.

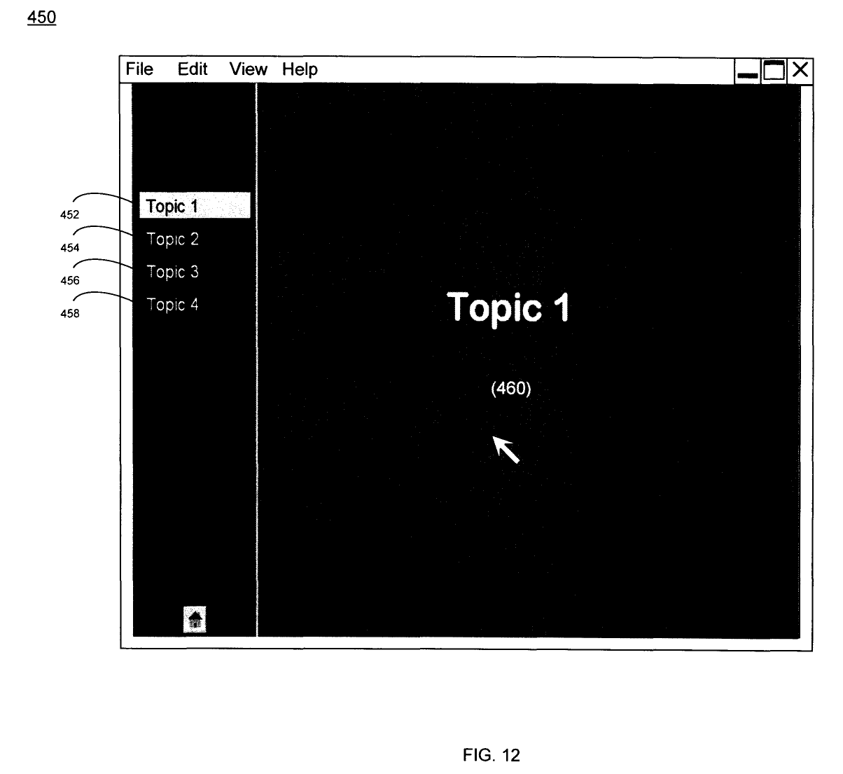

Referring also to FIG. 12, there is shown an alternative embodiment non-sequential content template 450 that includes four sidebar data objects 452, 454, 456, 458, each of which may be associated with one or more content pages. For example, sidebar data object 452 is associated with content page 460 and each of sidebar data objects 454, 456, 458 may be associated with other unique content pages (not shown). Accordingly, the combination of sidebar data objects 452, 454, 456, 458 may form a non-sequential navigation object that allows for non-sequential navigation between the various unique content pages defined within template 450. Therefore, by selecting: sidebar data object 452, content page 460 may be rendered by content authoring process 10, 10′; and by selecting sidebar data object 454, a different content page (not shown) may be rendered by content authoring process 10, 10′, for example. Accordingly, when selecting sidebar data object 452, an animation sequence may be initiated that may result in the rendering of content page 460. This animation sequence (when initiated) may result in e.g., content page 460 fading into view, sliding into view from the left, or sliding into view from the right, for example.

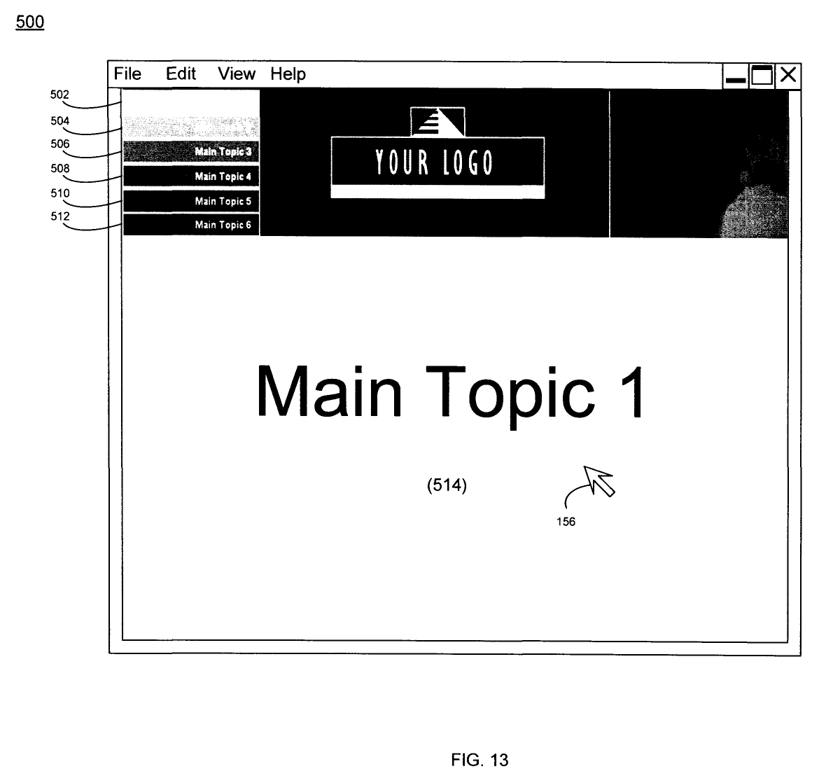

Referring also to FIG. 13, there is shown an alternative embodiment non-sequential content template 500 that includes six sidebar data objects 502, 504, 506, 508, 510, 512, each of which may be associated with one or more content pages. For example, sidebar data object 502 is associated with content page 514 and each of sidebar data objects 504, 506, 508, 510, 512 may be associated with other unique content pages (not shown). Accordingly, the combination of sidebar data objects 502, 504, 506, 508, 510, 512 may form a non-sequential navigation object that allows for non-sequential navigation between the various unique content pages defined within template 500. Therefore, by selecting: sidebar data object 502, content page 514 may be rendered by content authoring process 10, 10′; and by selecting sidebar data object 504, a different content page (not shown) may be rendered by content authoring process 10, 10′, for example. Accordingly, when selecting sidebar data object 502, an animation sequence may be initiated that may result in the rendering of content page 514. This animation sequence (when initiated) may result in e.g., content page 514 fading into view, sliding into view from the left, or sliding into view from the right, for example.

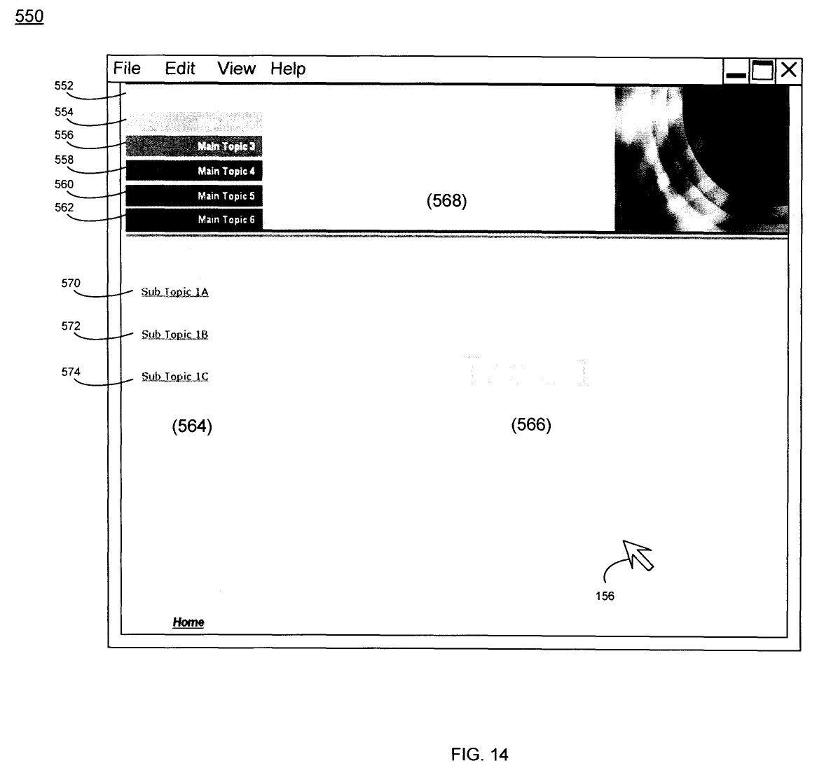

Referring also to FIG. 14, there is shown an alternative embodiment non-sequential content template 550 that includes six sidebar data objects 552, 554, 556, 558, 560, 562, each of which may be associated with one or more content pages. For example, sidebar data object 552 is associated with content pages 564, 566, 568 and each of sidebar data objects 554, 556, 558, 560, 562 may be associated with other unique content pages (not shown). Accordingly, the combination of sidebar data objects 552, 554, 556, 558, 560, 562 may form a non-sequential navigation object that allows for non-sequential navigation between the various unique content pages defined within template 550. Therefore, by selecting: sidebar data object 552, content pages 564, 566, 568 may be rendered by content authoring process 10, 10′; and by selecting sidebar data object 554, different content pages (not shown) may be rendered by content authoring process 10, 10′, for example. Accordingly, when selecting sidebar data object 552, an animation sequence may be initiated that may result in the rendering of content pages 564, 566, 568. This animation sequence (when initiated) may result in e.g., content pages 564, 566, 568 fading into view, sliding into view from the left, or sliding into view from the right, for example. In this particular example, content page 564 is shown to include three links 570, 572, 574 to other content pages (not shown).

While non-sequential content templates are described above as being used to create only a portion of e.g., a presentation, other configurations are possible and are considered to be within the scope of this disclosure. For example, a single non-sequential content template may be used to generate a complete slide show presentation. Accordingly, such a non-sequential content template may allow for non-sequential navigation between the various slide of the slide show using the non-sequential navigation object (e.g., the combination of data “bubbles” 202, 204, 206, 208, 210) defined within the non-sequential content template.

A number of implementations have been described. Nevertheless, it will be understood that various modifications may be made. Accordingly, other implementations are within the scope of the following claims.

What is claimed is:

1. A content authoring method comprising:
defining a selected non-sequential content template, wherein the selected non-sequential content template defines a plurality of data objects and includes at least one non-sequential navigation object that allows for non-sequential navigation between at least a portion of the plurality of data objects defined within the selected non-sequential content template.

2. The content authoring method of claim 1 further comprising:
storing a plurality of non-sequential content templates in a data repository, wherein the selected non-sequential content template is chosen from the plurality of non-sequential content templates.

3. The content authoring method of claim 2 wherein the data repository is chosen from the group consisting of: a database and a directory structure.

4. The content authoring method of claim 1 wherein the selected non-sequential content template includes:
two or more discrete animation sequences for applying to at least a portion of the plurality of data objects.

5. The content authoring method of claim 4 wherein the plurality of data objects includes:
a first data object, and
a second data object; and wherein the two or more discrete animation sequences includes:
a first animation sequence for applying to the first data object, and
a second animation sequence for applying to the second data object.

6. The content authoring method of claim 1 further comprising:
modifying the selected non-sequential content template.

7. The content authoring method of claim 6 wherein modifying the selected non-sequential content template includes at least one of:
adding one or more additional data objects to the selected non-sequential content template;
adding one or more discrete animation sequences to the selected non-sequential content template;
deleting one or more of the plurality of data objects from the selected non-sequential content template;
deleting one or more discrete animation sequences from the selected non-sequential content template; and
modifying one or more of the plurality of data objects defined within the selected non-sequential content template to include customer content.

8. The content authoring method of claim 7 wherein the customer content is chosen from the group consisting of: customer text; customer images; customer animations; customer video tracks; and customer audio tracks.

9. The content authoring method of claim 1 wherein the selected non-sequential content template is configured to assist a user in creating content.

10. The content authoring method of claim 9 wherein the content is a slideshow presentation file.

11. The content authoring method of claim 9 wherein the content is a word processor file.

12. A computer program product residing on a computer readable medium having a plurality of instructions stored thereon that, when executed by a processor, cause the processor to perform operations comprising:
defining a selected non-sequential content template, wherein the selected non-sequential content template defines a plurality of data objects and includes at least one non-sequential navigation object that allows for non-sequential navigation between at least a portion of the plurality of data objects defined within the selected non-sequential content template.

13. The computer program product of claim 12 further comprising instructions for:
storing a plurality of non-sequential content templates in a data repository, wherein the selected non-sequential content template is chosen from the plurality of non-sequential content templates.

14. The computer program product of claim 13 wherein the data repository is chosen from the group consisting of: a database and a directory structure.

15. The computer program product of claim 12 wherein the selected non-sequential content template includes:
two or more discrete animation sequences for applying to at least a portion of the plurality of data objects.

16. The computer program product of claim 15 wherein the plurality of data objects includes:
a first data object, and
a second data object; and wherein the two or more discrete animation sequences includes:
a first animation sequence for applying to the first data object, and
a second animation sequence for applying to the second data object.

17. The computer program product of claim 15 further comprising instructions for:
modifying the selected non-sequential content template.

18. The computer program product of claim 17 wherein the instructions for modifying the selected non-sequential content template includes instructions for at least one of:
adding one or more additional data objects to the selected non-sequential content template;
adding one or more discrete animation sequences to the selected non-sequential content template;
deleting one or more of the plurality of data objects from the selected non-sequential content template;
deleting one or more discrete animation sequences from the selected non-sequential content template; and
modifying one or more of the plurality of data objects defined within the selected non-sequential content template to include customer content.

19. The computer program product of claim 18 wherein the customer content is chosen from the group consisting of: customer text; customer images; customer animations; customer video tracks; and customer audio tracks.

20. The computer program product of claim 19 wherein the selected non-sequential content template is configured to assist a user in creating content.

21. The computer program product of claim 20 wherein the content is a slideshow presentation file.

22. The computer program product of claim 20 wherein the content is a word processor file.
